(19) United States
(12) Patent Application Publication
(10) Pub. No.: US 2008/0056354 A1
(43) Pub. Date: Mar. 6, 2008

(54) Transcoding Hierarchical B-Frames with Rate-Distortion Optimization in the DCT Domain

(75) Inventors: Xiaoyan Sun, Redmond, WA (US); Huifeng Shen, Redmond, WA (US); Feng Wu, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/468,253

(22) Filed: Aug. 29, 2006

(51) Int. Cl. H04N 7/12

(52) U.S. Cl. 375/240.12; 375/240.26

(57) ABSTRACT

Transcoding hierarchical B-frames with rate-distortion optimization in the DCT domain is described. More particularly, and in one aspect, input media content is transcoded from an original bit rate to a reduced bit rate. The input media content includes multiple hierarchical bidirectional frames (“B-frames”), multiple intra-frames (I-frames), and multiple predictive frames (P-frames). Each B-frame is open-loop transcoded in view of the reduced bit rate by optimizing texture and motion rate-distortion in the DCT domain to generate a respective portion of transcoded media content. The transcoded media content, which includes transcoded B-frames, I-frames, and P-frames, is provided to a user for viewing.

### BACKGROUND

Encoded video media content is commonly transmitted over networks for presentation by different types of display devices. To provide practical video-related services, encoded content is generally transcoded prior to transmission to adapt content bit rates to varying network data throughput conditions and/or characteristics of terminal devices used to present decoded video bitstreams. Motion information in an encoded video stream is generally designed for a high bit rate. Transcoding techniques for rate reduction include close-loop techniques and open-loop techniques. Respective ones of these techniques can be used to transcode frames in hierarchical-B structures for prediction accuracy and temporal scalability. FIG. 1 shows a typical hierarchical-B (H-B) coding structure 100. As illustrated in FIG. 1, an H-B structure typically includes I-frames, B-frames, and P-frames. In FIG. 1, an I/P frame means I-frame or P-frame.

Close-loop transcoding techniques, especially cascade transcoding techniques, are commonly used to transcode unidirectional prediction frames (P-frames) and intra frames (I-frames). Open-loop transcoding techniques in the DCT domain are typically used to transcode bidirectional prediction frames (B-frames). B-frames use more bits (as compared to P-frames) to specify motion information for better prediction. If this motion information is used directly at a lower target bit rate, transcoded video quality suffers. To address this quality reduction, conventional pixel-domain transcoding rate-distortion (R-D) optimization techniques may be used to refine the motion information in view of the reduced bit rate. However, these conventional techniques are complex and time-consuming. They require complete decoding and re-encoding of a B-frame in the pixel domain to directly calculate distortions caused by motion and mode change from sum of absolute difference (SAD) or sum of square difference (SSD) between coded signal and interpolated prediction signal. Such complex and time-consuming operations reduce coding performance and are not suitable for real-time applications.

### SUMMARY

Transcoding hierarchical B-frames with rate-distortion optimization in the DCT domain is described. More particularly, and in one aspect, input media content is transcoded from an original bit rate to a reduced bit rate. The input media content includes multiple hierarchical bidirectional frames (“B-frames”), multiple intra-frames (I-frames), and multiple predictive frames (P-frames). Each B-frame is open-loop transcoded in view of the reduced bit rate by optimizing texture and motion rate-distortion in the DCT domain to generate a respective portion of transcoded media content. The transcoded media content, which includes transcoded B-frames, I-frames and P-frames, is provided to a user for viewing.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows a hierarchical-B coding structure, according to one embodiment.

FIG. 2 shows an exemplary system for transcoding hierarchical B-frames with rate-distortion optimization in the DCT domain, according to one embodiment.

FIG. 3 shows an exemplary set of relationships between total distortion, motion distortion, and texture distortion in hierarchical B-frame transcoding, according to one embodiment.

FIG. 4 shows an exemplary relationship between a derivative ratio of texture distortion and texture rate in view of a quantizer Q, according to one embodiment.

FIG. 5 shows the exemplary set of partition modes for a macroblock of a hierarchical B-frame, according to one embodiment.

FIG. 6 shows an exemplary framework of transcoder of FIG. 2, according to one embodiment.

FIG. 7 shows an exemplary procedure for transcoding hierarchical B-frames with rate-distortion optimization in the DCT domain, according to one embodiment.

FIG. 8 shows further aspects of the exemplary procedure of FIG. 7 for transcoding hierarchical B-frames with rate-distortion optimization in the DCT domain, according to one embodiment.

FIG. 9 shows an exemplary procedure to identify, for a macroblock of hierarchical B-frame (“B-frame”), a particular candidate mode of one or more possible candidate modes and a particular set of motion vectors associated with minimal estimated rate-distortion values to transcode the B-frame, according to one embodiment.

FIGS. 10-13 each shows an exemplary respective procedure to make motion information refinement and mode decisions for a particular macroblock based on the initial macroblock mode of 8×8, 16×8, 8×16, or 16×16 associated with the macroblock, according to respective embodiments.

FIG. 14 shows an exemplary procedure to determine a sub-macroblock mode decision, according to one embodiment.

FIGS. 15-21 show exemplary respective procedures to compute motion R-D cost if the initial sub-macroblock/macroblock mode is based on 4×4, 8×4, 4×8, 8×8, 8×16, 16×8 or 16×16, according to respective embodiments.

### DETAILED DESCRIPTION

### Overview

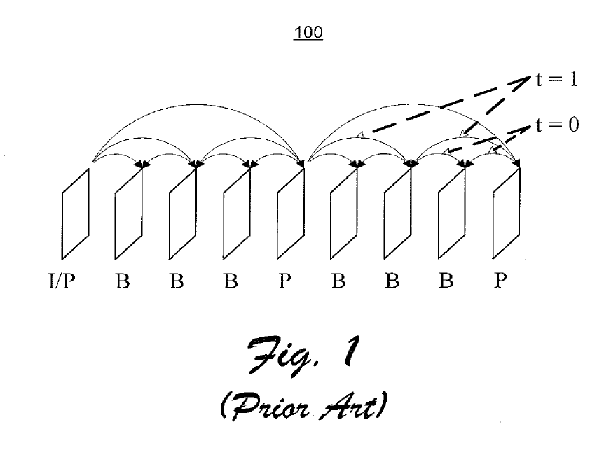

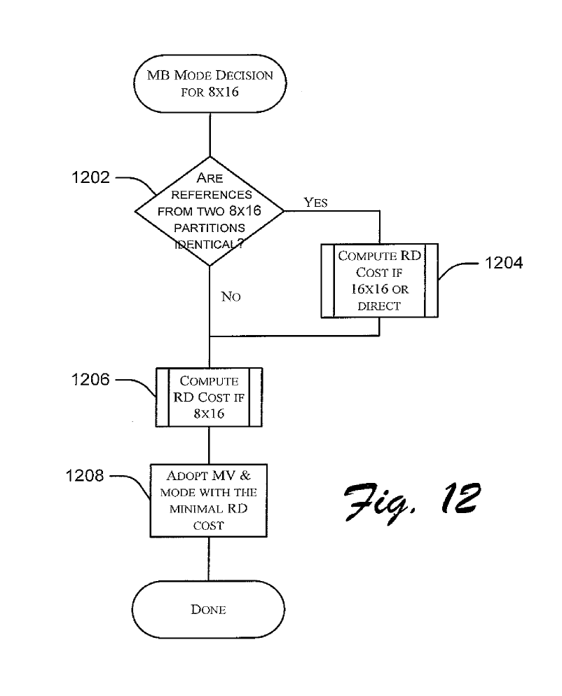

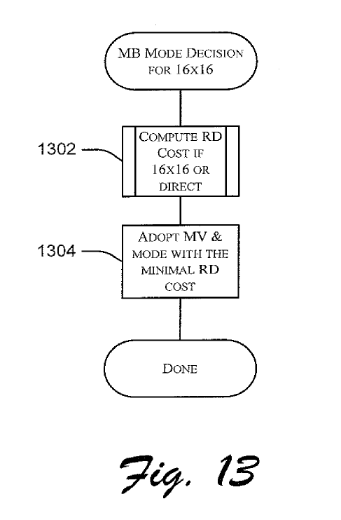

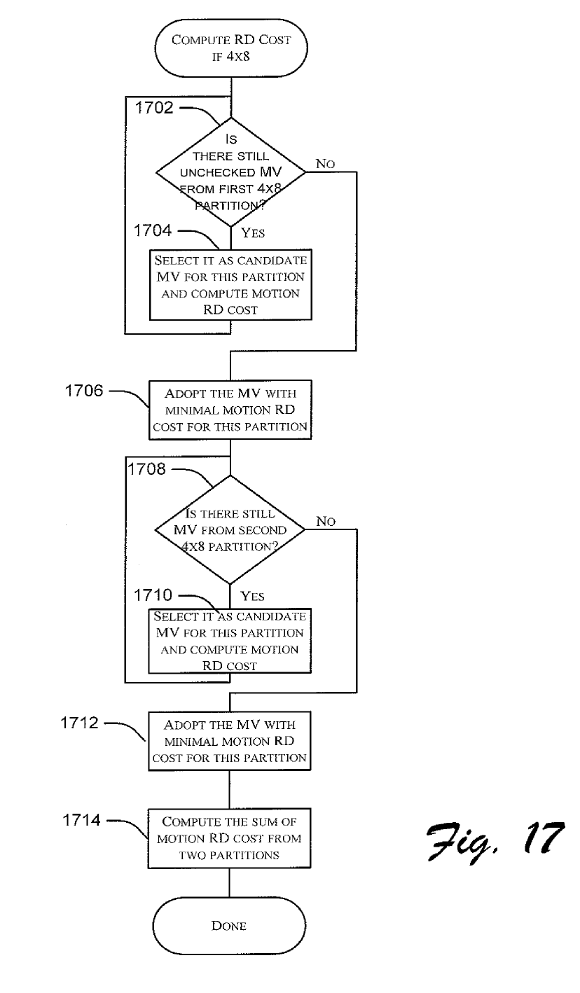

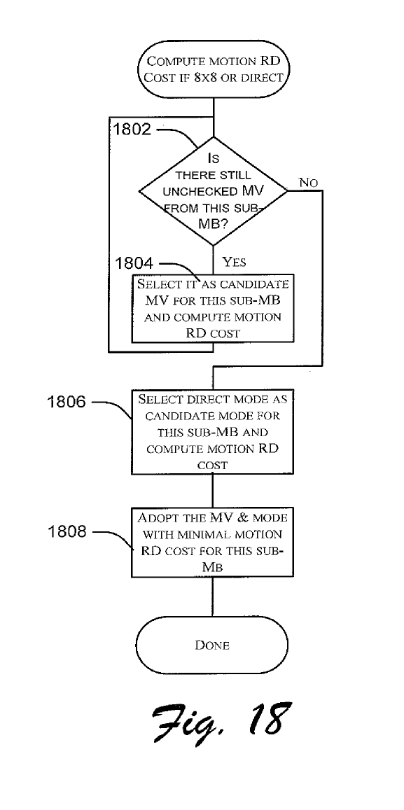

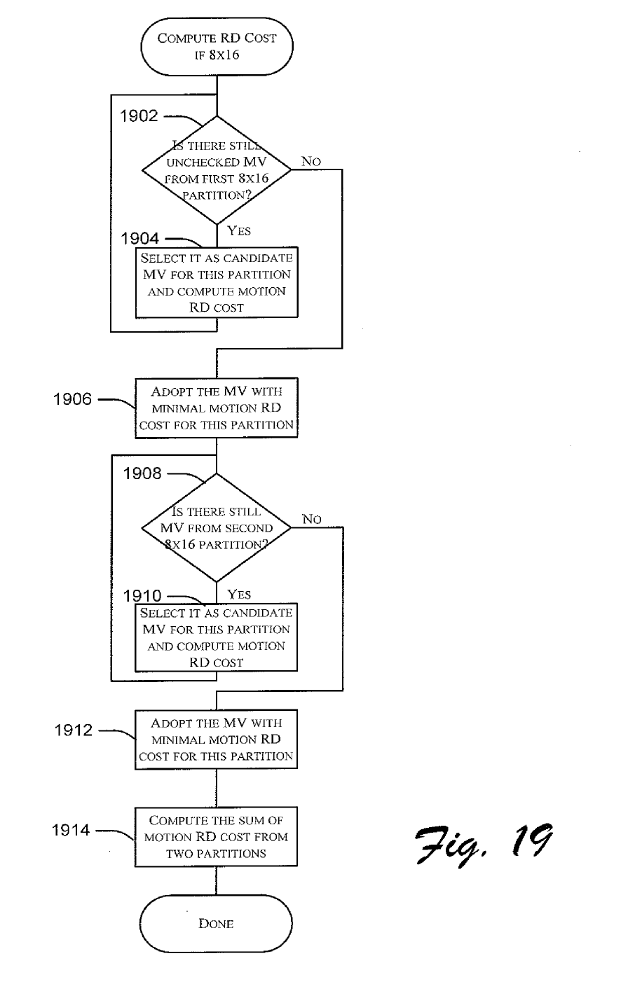

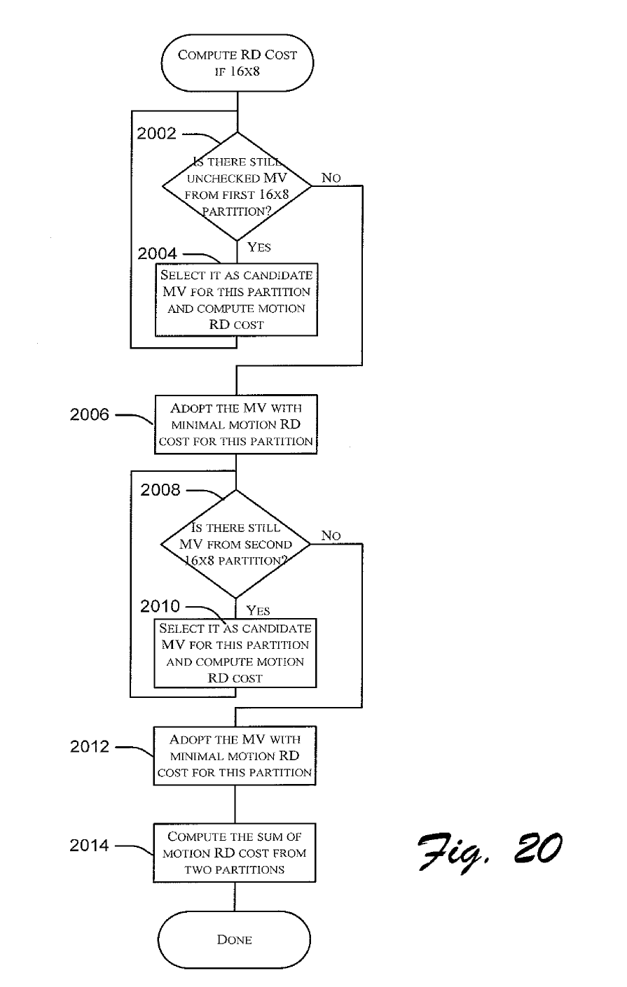

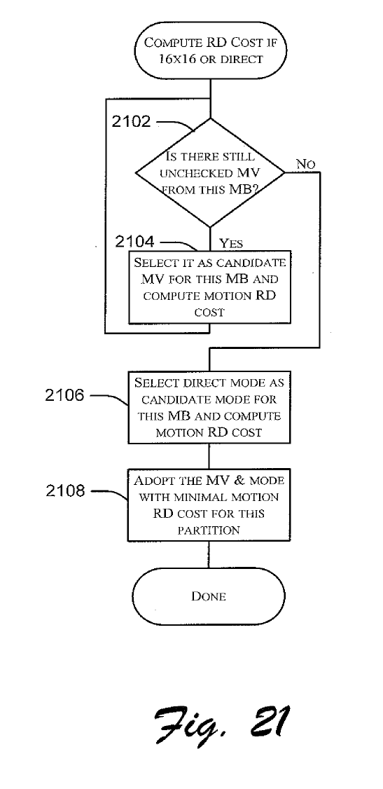

Systems and methods for transcoding hierarchical B-frames with joint R-D modeling are described with respect to FIGS. 1 through 21. In general, during entropy decoding operations, the systems and methods extract motion vectors and mode information from frames of input media content. For each B-frame, the systems and methods implement novel joint R-D modeling operations in the DCT domain (as compared to the pixel domain) for open-loop transcoding that independently optimizes texture rate-distortion and motion rate-distortion.

To this end, the systems and methods directly and respectively estimate distortions caused by motion and mode change in view of a target reduced bit rate from motion vector (MV) variation and power spectrum (PS) of prediction signals generated from the input media content stream. Based on these estimates, the systems and methods refine the B-frame's motion and mode information for each macroblock of the frame to minimize motion and texture R-D costs. The refined motion vectors and new modes are integrated to generate transcoded B-frames. In this implementation, the systems and methods transcode other encoded frame types such as I-frames and P-frames using conventional transcoding techniques.

These and other aspects of the systems for transcoding hierarchical B-frames with rate-distortion optimization in the DCT domain are now described in greater detail.

### An Exemplary System

Although not required, systems and methods for transcoding hierarchical B-frames with rate-distortion optimization in the DCT domain are described in the general context of computer-executable instructions executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

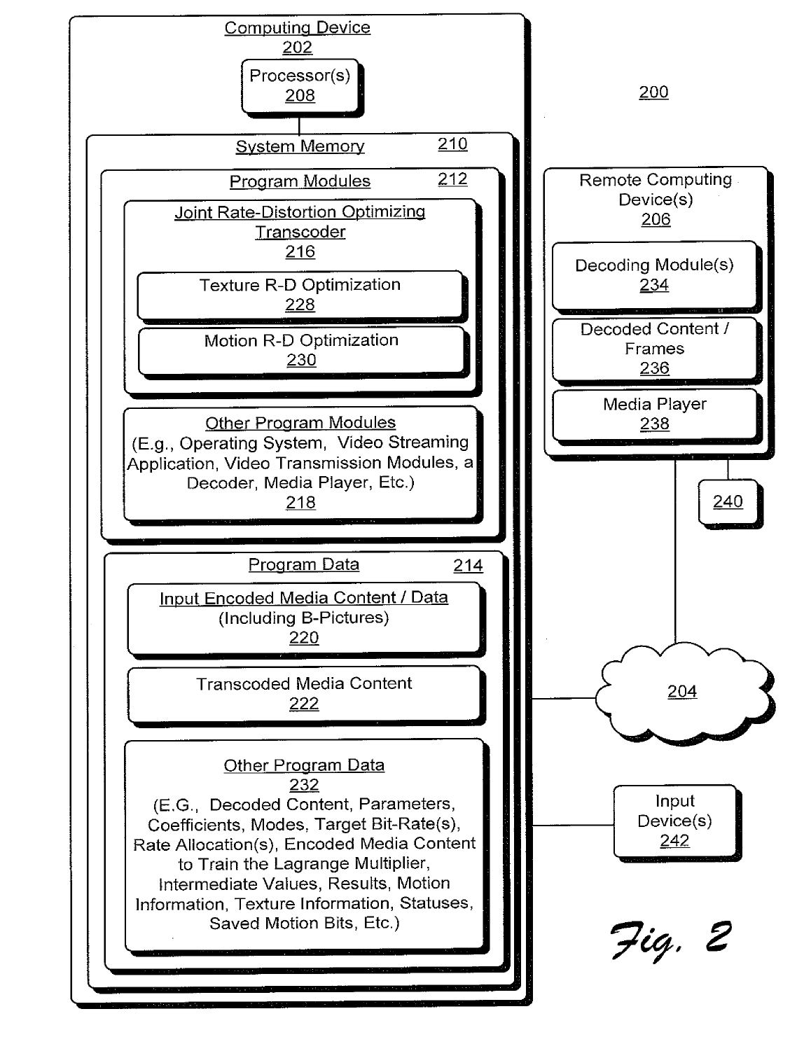

FIG. 2 shows an exemplary system 200 for transcoding hierarchical B-frames with rate-distortion optimization in the DCT domain, according to one embodiment. System 200 includes a computing device 202 coupled across a network 204 to one or more remote computing devices 206. Computing device 202 and/or remote computing device 206 may be for example a general purpose computing device, a server, a laptop, a mobile computing device, and/or so on. Network 204 may include any combination of a local area network (LAN) and a general wide area network (WAN) communication environments, such as those which are commonplace in offices, enterprise-wide computer networks, intranets, and the Internet. Computing device 202 and remote computing device 206 include one or more respective processors coupled to a system memory comprising computer-program modules and program data. Each respective processor is configured to fetch and execute computer-program instructions from respective ones of the computer-program modules and obtain data from program data.

For example, computing device 202 includes processor 208 coupled to system memory 210. Processor 208 may be a microprocessor, microcomputer, microcontroller, digital signal processor, etc. System memory 210 includes, for example, volatile random access memory (e.g., RAM) and non-volatile read-only memory (e.g., ROM, flash memory, etc.). System memory 210 comprises program modules 212 and program data 214. Program modules 212 include, for example, joint rate-distortion optimizing transcoder (“transcoder”) 216 and “other program modules” 218 such as an Operating System (OS) to provide a runtime environment, a video streaming application that leverages operations of transcoder 216, bitstream transmission modules, a decoder, a media player, device drivers, and/or so on.

Transcoder 216 receives coded (compressed) media content 220 (“input content 220”) for transcoding to another coded media content format represented by transcoded media content 222 (“transcoded content 222”). In one implementation, these transcoding operations including adapting bit rate of input content 220 to address differing network data throughput conditions, terminal device characteristics (e.g., characteristics associated with remote computing device 206), and/or so on. To this end, and responsive to receiving input content 220, transcoder 216 entropy decodes respective frames (pictures) of the input content 220. During these decoding operations, motion vectors and mode information (i.e., block partition statuses of macroblocks) are extracted. Transcoder 216 uses this extracted motion and mode information to refine motion vectors and make mode decisions to comply with a target bit rate when generating transcoded content 222.

During transcoding operations, transcoder selectively transcodes different types of frames of input content 220. For example, if an input frame is an I-frame or a P-frame, transcoder 216 utilizes conventional transcoding operations to generate respective transcoded I-frames or P-frames. For example, transcoder 216 downscales the decoded I or P frame to the desired resolution and performs R-D optimization to generate a respective quantization step for each macroblock. Transcoder 216 uses respective ones of the quantization steps to encode the I-frame and P-frame portions of transcoded content 222.

However, when transcoding hierarchical B-frames, and in contrast to conventional transcoding techniques, transcoder 216 inputs the extracted motion vectors and mode information associated with the B-frame into a joint R-D model that independently optimizes R-D for texture rate (rate consumed by coding quantized DCT coefficients) and motion rate (rate spent in coding macroblock modes, block modes and motion vectors). Transcoder 216 utilizes these jointly, but independently optimized texture and motion rates to refine the extracted motion vectors and make integrated mode decisions to arrive at minimal R-D cost for each macroblock. Transcoder 216 uses the refined motion vectors and integrated mode decisions to encode each macroblock of the decoded B-frame in view of a target bit rate (dictated by network conditions and/or terminal display/device characteristics) to generate respective portions of transcoded content 222. (Conventional DCT-domain B-frame transcoding techniques achieve rate reduction by modifying only the DCT coefficients (i.e., lowering only the rate of texture, not motion).

Exemplary joint R-D model texture rate and motion rate optimizing operations of transcoder 216 are now described.

### An Exemplary Joint Rate-Distortion Model

A conventional rate-distortion (R-D) model is typically used in video coding to find a combination of coding parameters that minimizes total distortion under a constraint of total rate. This conventional R-D model is as follows:

I*=argmin_{I}J(S,I|λ), (1)

With J(S,I|λ)=Dₜₒₜₐₗ(S,I)+λRₜₒₜₐₗ(S,I). In equation (1), S=(S₁, S₂, . . . , S_{K}) denotes K encoding macroblocks and I=(I₁, I₂, . . . I_{K}) denotes the coding parameters for S. Dₜₒₜₐₗ(S,I) and Rₜₒₜₐₗ(S,I) represent the total distortion and total rate, respectively, which are resulting from the quantization of S given a combination of coding parameters I. λ represents the Lagrange multiplier. J denotes the joint distortion function combined of texture distortion and total bit rate. Use of this conventional R-D model to directly transcode hierarchical B-frames is very time-consuming. This is because a full decoding and re-encoding including motion estimation and mode decision in pixel domain are required to get an optimal result for encoding every macroblock. Differently, the joint R-D optimizing operations of transcoder 216 are preformed in the DCT domain. It means that the pixel domain motion estimation and mode decision are not involved in the R-D optimization process so that the computational complexity is relatively low.

In this implementation, transcoding module 216 separates total rate into two parts: motion rate and texture rate, as denoted in (2).

Rₜₒₜₐₗ=Rₜₑₓₜᵤᵣₑ+Rₘₒₜᵢₒₙ (2)

Motion rate (Rₘₒₜᵢₒₙ) represents a rate associated with encoding module 216 operations to code macroblock modes, block modes, and motion vectors. Texture rate (Rₜₑₓₜᵤᵣₑ) represents the rate associated with encoding module 216 operations to code quantized DCT coefficients.

Traditional DCT-domain P-frame transcoding techniques reduce rate by modifying only the DCT coefficients. In other words, Rₜₒₜₐₗ is decreased by merely lowering the rate of the Rₜₑₓₜᵤᵣₑ. In contrast, encoding module 216 reduces not only Rₜₑₓₜᵤᵣₑ, but also reduces Rₘₒₜᵢₒₙ to reduce rate in DCT-domain hierarchical B-frame transcoding. Encoding module 216 downsizes Rₘₒₜᵢₒₙ since an H-B picture uses more bits for coding motion information as compared to the number of bits used to code motion information in a P-frame. Additionally, as target bit rate decreases, Rₘₒₜᵢₒₙ plays an increasingly significant role in overall coding performance.

Modifying motion and texture encoding rates introduces two different types of distortion. One type of distortion is induced when encoding module 216 modifies DCT coefficients. Another type of distortion is introduced when encoding module 216 alters motion information independent of a full pixel-domain motion compensation loop. Let Dₜₑₓₜᵤᵣₑ denote the distortion caused by transcoder 216 downscaling of texture when motion information is reused in a lossless manner during transcoding. Let Dₘₒₜᵢₒₙ denote the distortion introduced transcoder 216 responsive to adjusting motion relative to unchanged texture.

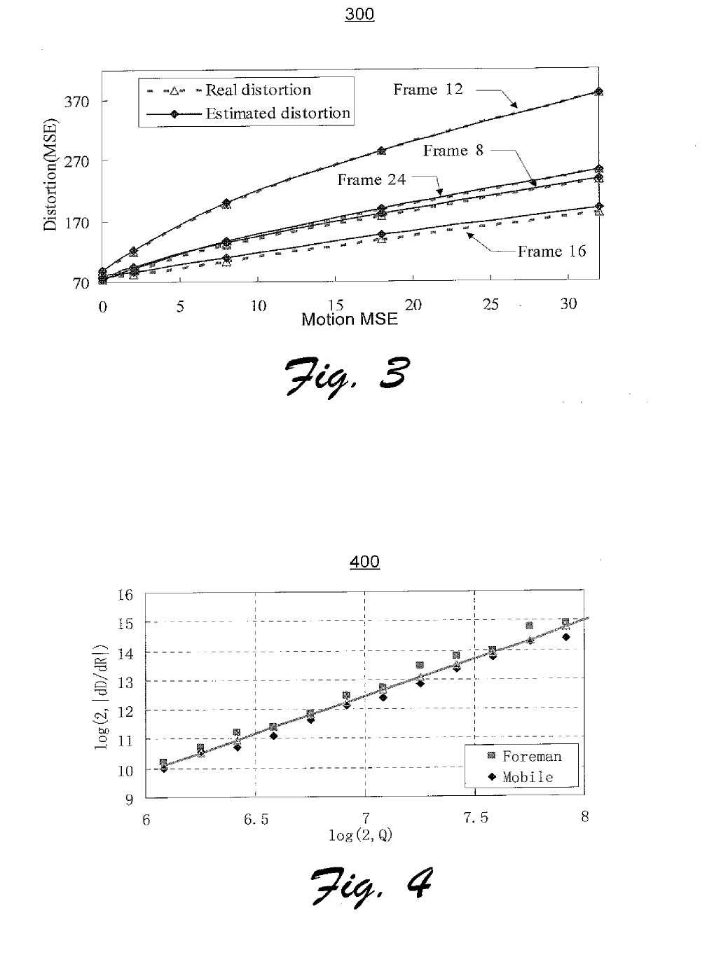

FIG. 3 shows an exemplary set of relationships between Dₜₒₜₐₗ, Dₘₒₜᵢₒₙ and Dₜₑₓₜᵤᵣₑ in hierarchical B-frame transcoding, according to one embodiment. For purposes of example, the 8^{th}, 12^{th}, 16^{th} and 24^{th} frames of the known Foreman (CIF) sequence are used to illustrate these exemplary relationships. In this implementation, and for purposes of exemplary illustration, variances of motion vectors are set to be 2, 8, 18 and 32. In another implementation, the variances are set to one or more other values. The actual values of Dₜₒₜₐₗ are shown by dashed lines, whereas the solid lines represent the values of (Dₘₒₜᵢₒₙ+Dₜₑₓₜᵤᵣₑ). As shown, total distortion Dₜₒₜₐₗ in hierarchical B-frame transcoding can be approximated by the sum of distortions, Dₜₑₓₜᵤᵣₑ and Dₘₒₜᵢₒₙ, as follows:

Dₜₒₜₐₗ≈Dₜₑₓₜᵤᵣₑ+Dₘₒₜᵢₒₙ (3)

Dₘₒₜᵢₒₙ is highly independent of texture rate in a wide range. So, according to (2) and (3), the optimal problem in this implementation is modeled as:

min_{I}J(S,I|λ)=min_{I}(Jₘₒₜᵢₒₙ(S,I|λ))+min_{I}(Jₜₑₓₜᵤᵣₑ(S,I|λ)) (4)

here,

Jₘₒₜᵢₒₙ(S,I|λ)=Dₘₒₜᵢₒₙ(S,I)+λRₘₒₜᵢₒₙ(S,I), (5)

Jₜₑₓₜᵤᵣₑ(S,I|λ)=Dₜₑₓₜᵤᵣₑ(S,I)+λRₜₑₓₜᵤᵣₑ(S,I). (6)

### Therefore, transcoder 216 adjusts the joint optimization problem in hierarchical B-frame transcoding to two independent optimization problems, motion R-D optimization and texture R-D optimization.

More particularly, transcoder 216 optimizes motion R-D by modifying motion vectors and macroblock modes, and optimizes texture R-D by adjusting quantization parameters. To this end, and in this implementation, transcoder 216 includes texture R-D optimization module 228 and motion R-D optimization module 230.

### Texture R-D Optimization

Texture R-D optimization is separate from motion R-D optimization in the implemented R-D model. Thus, transcoding module 216 infers that Jₜₑₓₜᵤᵣₑ(S,I|λ) is determined by quantization parameter and Lagrange multiplier, irrespective of macroblock mode and motion information. As distortion and rate of DCT coefficients are determinable, texture R-D optimization module 228 determines the Lagrange multiplier i for the texture R-D model (denoted by (6)) in DCT-domain hierarchical B-picture transcoding.

If the distortion-rate function Dₜₑₓₜᵤᵣₑ(Rₜₑₓₜᵤᵣₑ) is strictly convex, the minimum of the Lagrange cost function is given by setting its derivative to zero, i.e.,

$$\frac{\partial {J}_{texture}}{\partial {R}_{texture}} = \frac{\partial {D}_{texture}}{\partial {R}_{texture}} + λ = 0 \\ which yields \\ λ = \vert \frac{\partial {D}_{texture}}{\partial {R}_{texture}} \vert . \qquad ( 7 )$$

In the derivation of λ, the model of rate (R) and distortion (D) corresponding to quantization parameter is shown in (8)

$$\{ \begin{matrix}R \approx {aQ}^{- α} \\ D \approx {bQ}^{β}\end{matrix} , \qquad ( 8 )$$

wherein a, b, α, β>0 are parameters that depend on the distribution property of DCT coefficients of a video content. Assuming that DCT coefficients have a Cauchy distribution and a uniform quantizer is operated with quantization step size Q, it follows that

$$\vert \frac{\partial {D}_{texture}}{\partial {R}_{texture}} \vert = \vert \frac{\partial {D}_{texture}}{\partial Q} \times \frac{\partial Q}{\partial {R}_{texture}} \vert \approx c {Q}^{γ} , \qquad ( 9 )$$

wherein c and γ are parameters where

$$c = \frac{b β}{a ( α + 1 )} and γ = α + β .$$

Formula (9) can also be derived to a linear model, as follows:

$${log}_{2} \vert \frac{\partial {D}_{texture}}{\partial {R}_{texture}} \vert \approx γ {log}_{2} Q + {log}_{2} c . \qquad ( 10 )$$

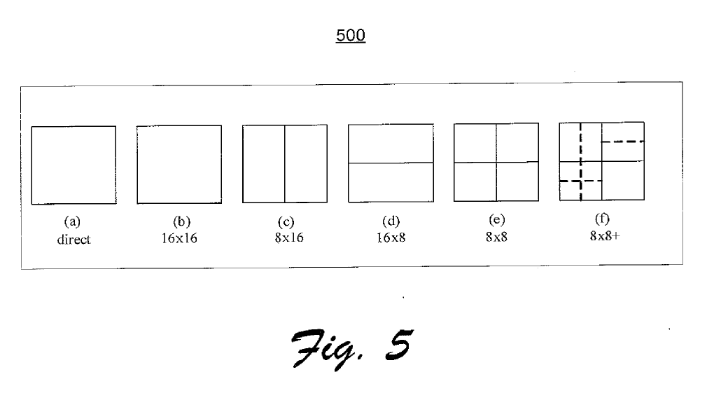

To obtain the relationship between ∂Dₜₑₓₜᵤᵣₑ/∂Rₜₑₓₜᵤᵣₑ and Q, texture R-D optimization module 228 transcodes the pre-encoded several streams in DCT domain to different low bit rates with different Q by reusing the unchanged motion and mode information. For purposes of exemplary illustration, such pre-encoded media content (streams) are shown as a respective portion of “other program data” 232. In another implementation, the pre-encoded content is on a different computing device. Thus, the relationship associated with the Lagrange multiplier can be trained on computing device 102 and/or a different computing device 102 or 206. The results of example Foreman and Mobile sequences are showed in the example of FIG. 4. In the example of FIG. 4, the bold line is linearly flitted with the least square method, depicting the following function.

$${log}_{2} \vert \frac{\partial {D}_{texture}}{\partial {R}_{texture}} \vert \approx 2.54 {log}_{2} Q - 5.35 . \qquad ( 11 )$$

So, in this example, the approximation of the relationship between the quantizer Q and the Lagrange multiplier can be described as follows:

$$λ \approx \frac{1}{41} {Q}^{2.54} \qquad ( 12 )$$

### It can be appreciated that in other examples, the relationship between the quantizer Q and the Lagrange multiplier may differ.

FIG. 4 shows an exemplary relationship between ∂Dₜₑₓₜᵤᵣₑ/∂Rₜₑₓₜᵤᵣₑ and quantizer Q.

### An Exemplary Motion R-D Optimization Model

In the motion R-D model, motion R-D optimization module 230 determines motion rate in DCT-domain transcoding. Because of independent relationships between motion-induced distortion and texture-induced distortion, motion R-D optimization module 230 utilizes equal slope as an optimal solution to allocate rate between motion and texture. Thus, the same λ determined above with respect to the texture R-D optimization module is used in these exemplary motion R-D optimization operations. Since there are no reconstructed B-frames in DCT-domain transcoding, the relative distortion caused by motion mismatch can not be computed directly. However, the relationship between the motion vector mean-square error (MSE) and the resulting video distortion is approximately linear, that is

Dₘₒₜᵢₒₙ≈ΨDₘᵥ. (13)

### Here, Dₘᵥ denotes the motion vector mean-square error, and

$$Ψ = \frac{1}{2 \cdot {( 2 π )}^{2}} \int \int S ( {ω}^{r} ) ( {ω}_{1}^{2} + {ω}_{2}^{2} ) d {ω}^{r} . \qquad ( 14 )$$

In (14),

$${ω}^{r} = {( {ω}_{1} , {ω}_{2} )}^{t}$$

denotes two-dimensional frequency and

$$S ( {ω}^{⊥} )$$

denotes the power spectral density (PSD) of prediction signals got from the input motion information, which can be approximated by the PSD of the current reconstructed frame. Considering the bidirectional prediction and the pyramid structure of motion prediction (e.g., shown in FIG. 1 via respective arrows), motion distortion at stage t is as follows:

$${D}_{motion} \approx \frac{1}{4} {G}_{t} Ψ {D}_{mv} . \qquad ( 15 )$$

Here, Dₘᵥ includes the MSEs of both forward motion vector and backward motion vector and Gₜ denotes energy gain factor considering distortion propagation. As a pyramid structure, the energy gain factor can be formulated as

$${G}_{t} = 1 + 2 {\sum }_{n = 1}^{{2}^{t}} {( 1 - \frac{n}{{2}^{i}} )}^{2} \qquad ( 16 )$$

### Since the power spectral density is insensitive to the frames within a short time slot, it can be computed once for a group of pictures (GOP). For example, only Ψ of P frame is calculated and used for one GOP.

### R-D Optimal Motion Adjustment

As mentioned above, to improve performance when transcoding hierarchical B-frames to low bit rate, transcoder 216 adjusts the motion and mode information of macroblocks to fit a target bit rate. In this implementation, transcoder 216 saves motion bits through macroblock mode integration and motion-vector refinement operations.

FIG. 5 shows the exemplary set of partition modes for a macroblock of a hierarchical B-frame, according to one embodiment. In hierarchical B-frame transcoding, initial motion vectors and block partition status of macroblocks are obtained from the input stream 220. In this implementation, and since initial status of a macroblock can be one of the extracted modes (e.g., as shown in FIG. 5), transcoder 216 integrates mode, for example, as follows:

a→{a}

b→{b,a}

c→{c,b,a}

. . .

During mode integration, transcoder 216 also refines the extracted motion vectors. Based on the presented motion R-D model, transcoder 216 implements a mechanism for R-D optimal mode integration as well as motion refinement for a macroblock Sₖ by minimizing

Jₘₒₜᵢₒₙ(Sₖ,Iₖ)+λRₘₒₜᵢₒₙ(Sₖ,Iₖ), (17)

where the Iₖ denotes the possible macroblock modes.

For purposes of exemplary illustration, this motion vector refinement and mode integration is clarified by a first example (further examples are presented below in the section titled “An Exemplary Procedure”). In the case of 8×16 mode integration, four modes are considered as candidates: initial 8×16 mode, 16×16 mode with motion vectors from the left 8×16 block, 16×16 mode with motion vectors from the right 8×16 block and direct mode. The R-D cost is computed using (17) for each candidate and the minimal one is selected as the final macroblock mode. The texture information is directly re-quantized to form output stream 222.

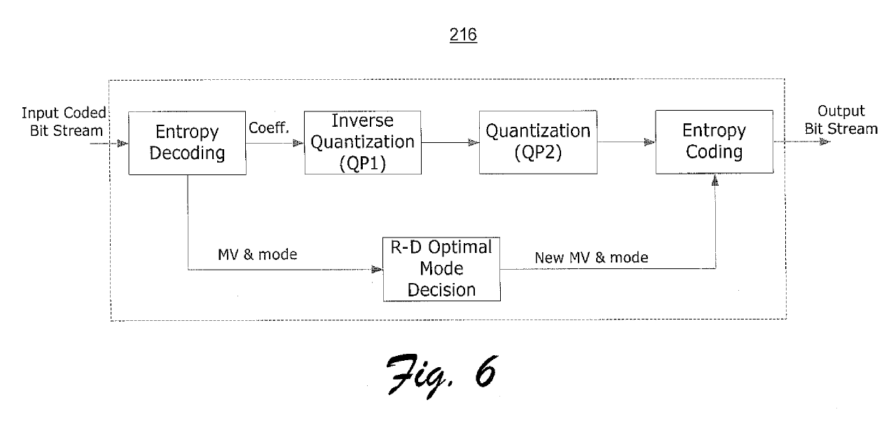

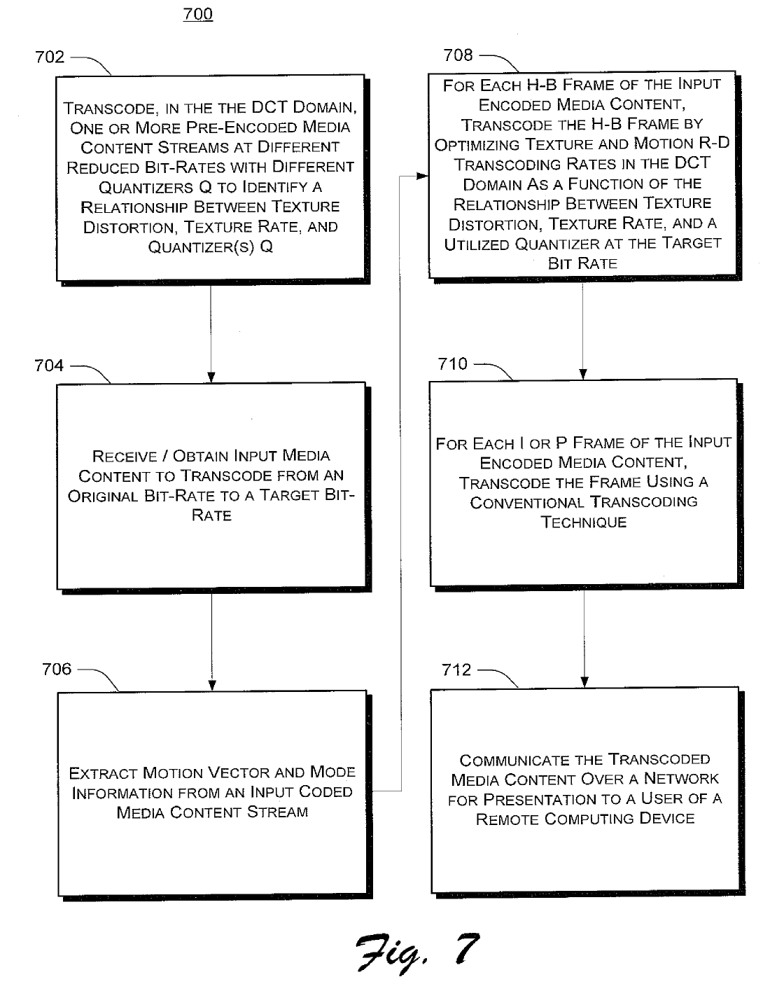

FIG. 6 shows an exemplary framework of transcoder 216 of FIG. 2, according to one embodiment. In this example, and for purposes of exemplary illustration, the above described operations of implementing the joint R-D model for optimizing hierarchical B-frame transcoding operations, including mode integration and motion refinement operations (e.g., as implemented by modules 228 and 230 of FIG. 2), are represented in the block titled “R-D Optimal Mode Decision”.

### An Exemplary Procedure

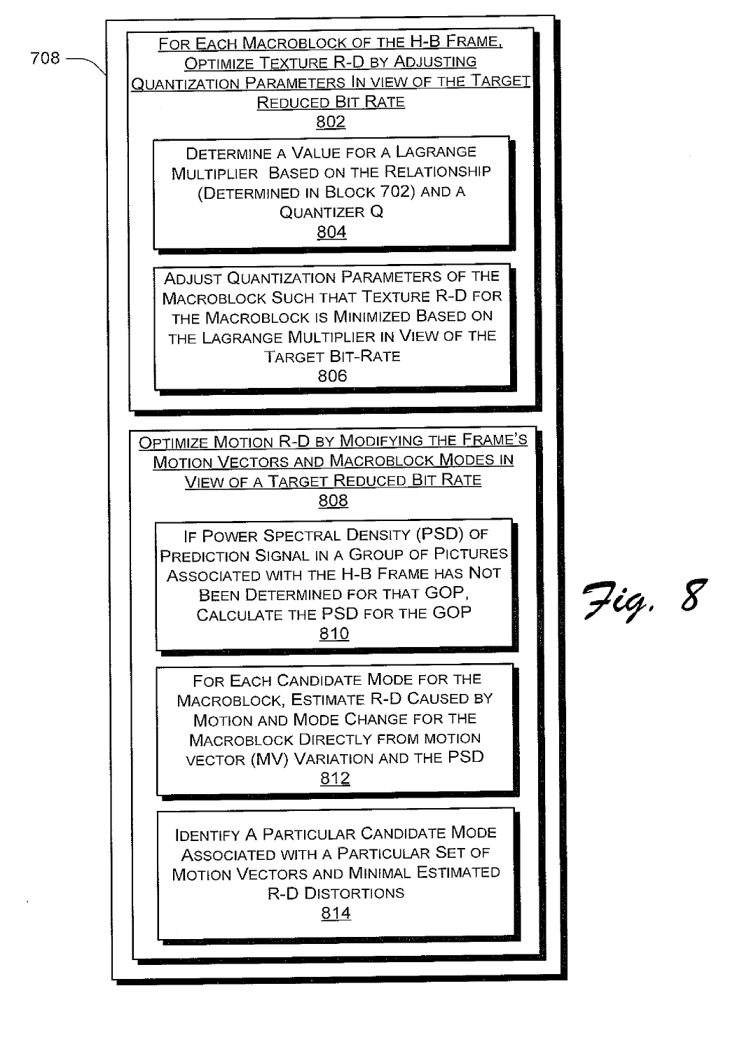

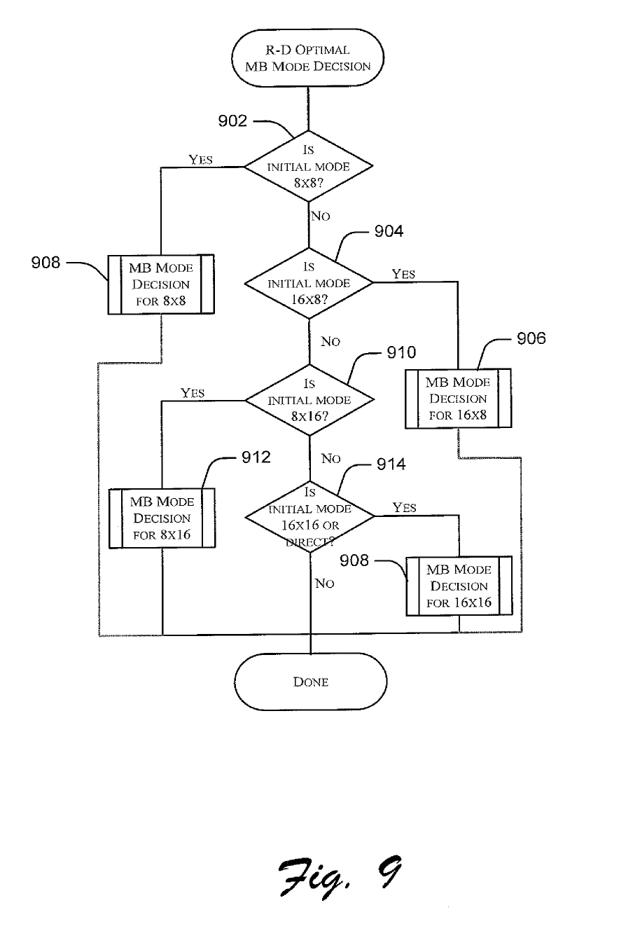

FIG. 7 shows an exemplary procedure for transcoding hierarchical B-frames with rate-distortion optimization in the DCT domain, according to one embodiment. For purposes of discussion, the operations of FIG. 7 are described in reference to components of other ones of the presented figures. For instance, in the description, the left-most digit of a component reference number identifies the particular figure in which the component first appears. For example, with respect to transcoder 216, the leftmost digit of the component is a “2”, indicating that transcoder 216 is first presented FIG. 2. In one implementation transcoder 216 and/or a video streaming application that leverages operations of transcoder 216 implements operations of procedure 700 (and associated operations described with respect to FIGS. 8 thorough 21).

Referring to FIG. 7, at block 702, one or more pre-encoded media content streams are transcoded in the DCT domain at different reduced bit rates with different quantizers Q. These operations are directed to identifying a relationship between texture distortion, texture rate, and different quantizers at varying bit rates. This relationship will be utilized in the operations of block 708 (described below) to identify minimal texture and motion R-D rates. At block 704, input coded media content 220 is received, or otherwise obtained. The coded media content 220 is for transcoding from an original bit rate to a target bit rate. At block 706, motion vectors and mode information is extracted from the input coded media content 220. At block 708, for each H-B frame (B-frame) encountered during transcoding operations, the H-B frame is transcoded by directly optimizing texture R-D and motion R-D in the DCT domain in view of a particular quantizer and a particular bit rate. These optimization operations are based on the relationship identified, and described above with respect to the operations of block 702, between texture distortion, texture rate, various quantizers, and varying bit rates. The operations of block 708 are described in greater detail below disrespect to FIG. 8.

At block 710, for each intra-frame (I-frame) or predictive frame (P-frame) identified during the transcoding operations, the identified frame is transcoded using one or more conventional transcoding techniques. For example, in one implementation, encountered I-frames and P-frames are transcoded according to conventional MPEG-2 transcoding techniques. At block 712, the transcoded media content 222 is presented to a user via a media player application. In one implementation, the transcoded media content 220 twos communicated over a network 104 for presentation to a user of remote computing device 206. In one implementation, such presentation is via media player 238 and presented on a display device 240.

FIG. 8 shows further aspects of the exemplary operations of FIG. 7 to transcode hierarchical B-frames by optimizing texture and motion R-D in the DCT domain, according to one embodiment. At block 802, for each macroblock of the hierarchical B-frame, texture R-D is optimized by adjusting quantization parameters in view of a target reduced bit rate. The operations of block 802 include operations of block 804 and block 806. At block 804, a value for a Lagrange multiplier is determined based on the identified relationship between texture distortion, texture rate, various quantizers, and different bit rates. This identified relationship was described above with respect to the operations of block 702 of FIG. 7. Referring to FIG. 8, block 806, quantization parameters of the macroblock are adjusted such that texture R-D for the macroblock is minimized based on the Lagrange multiplier and further in view of the target bit rate.

Next, at block 808, motion R-D is optimized by modifying the hierarchical B-frames motion vectors and macroblock modes in view of the target bit rate. The operations of block 808 include the operations of block 810 through block 814. Referring to block 810, if power spectral density (PSD) of a prediction signal associated with a group of pictures (GOP), that in turn is associated with the hierarchical B-frame, has not been determined for the GOP, the PSD is calculated for the GOP. In this implementation, the PSD is calculated one time for each GOP based on the assumption that the power spectral density is insensitive to frames within a short time slot. In another implementation, the PSD is calculated more frequently. At block 812, for each candidate mode for a macroblock, R-D caused by motion and mode change in the macroblock is estimated directly from motion vector variation and the PSD. At block 814, a particular candidate mode of one or more possible candidate modes that is associated with a particular set of motion vectors and minimal estimated R-D is identified. As described above, the macroblocks of B-frames that have been processed according to the operations of block 708 are transcoded based on the identified particular candidate mode and set of motion vectors with minimal estimated R-D.

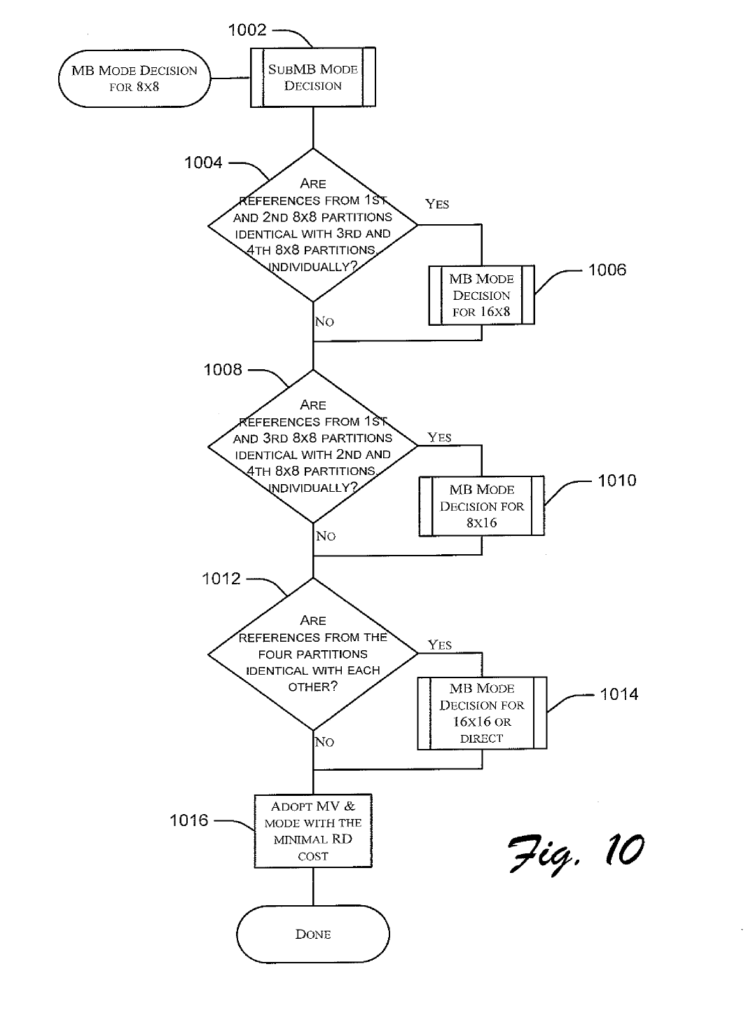

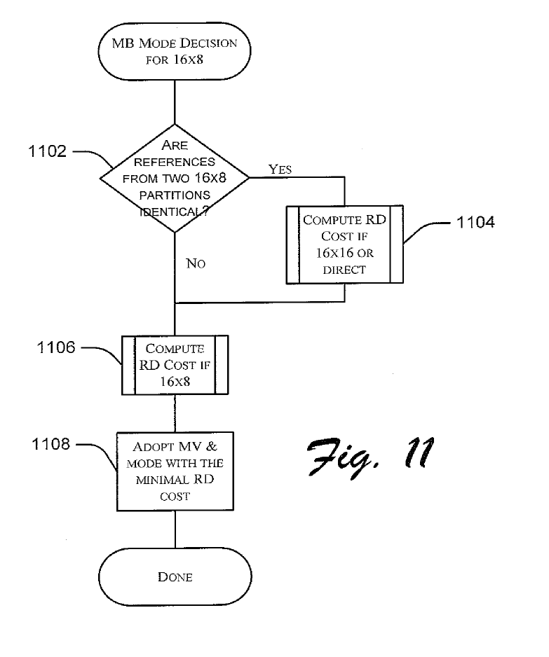

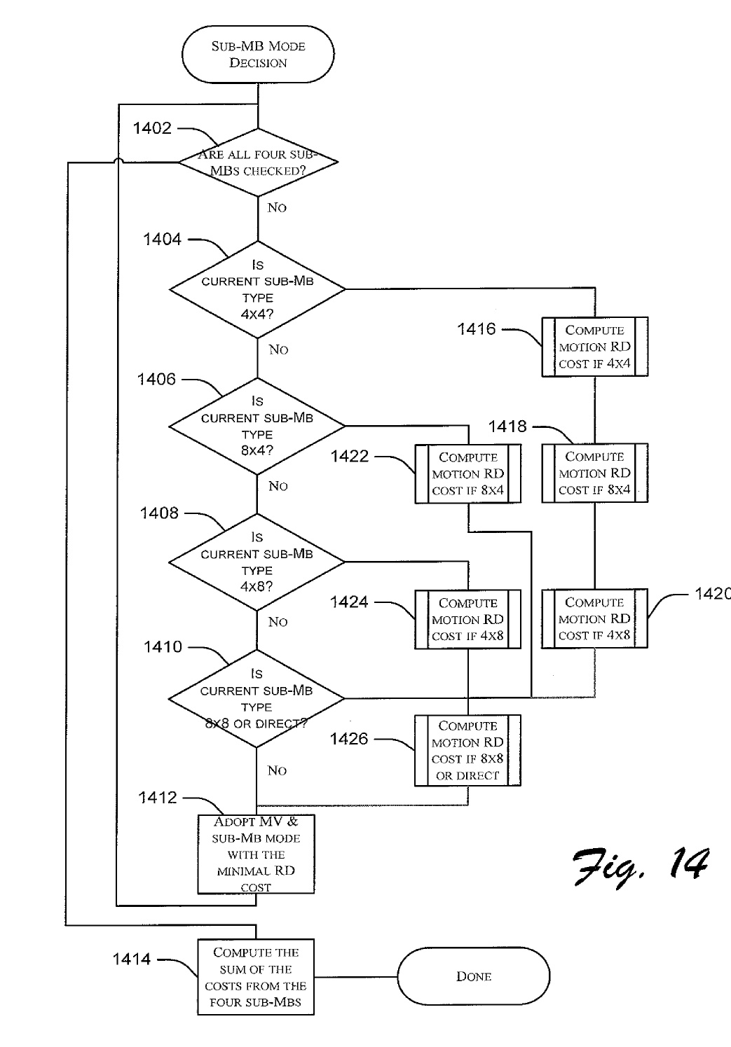

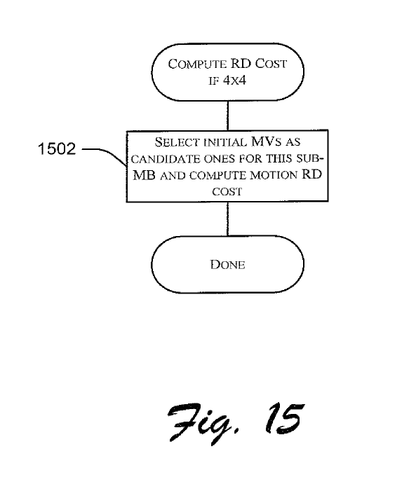

FIG. 9 shows an exemplary procedure to identify, for a macroblock of a hierarchical B-frame (“B-frame”), a particular candidate mode of one or more possible candidate modes and a particular set of motion vectors associated with minimal estimated R-D values to transcode the B-frame, according to one embodiment. More particularly, FIG. 9 shows an exemplary procedure to make an optimal R-D macroblock mode decision. In this implementation, this optimal R-D macroblock mode decision is based on whether the initial mode associated with the macroblock is 8×8, 16×8, 8×16, or 16×16. It can be appreciated that in a different implementation, the initial mode can be based on different initial mode configurations. FIGS. 10-13 each show an exemplary respective procedure to make motion information refinement and mode decisions for a particular macroblock based on the initial mode of 8×8, 16×8, 8×16, or 16×16 associated with the macroblock, according to respective embodiments. FIG. 14 shows an exemplary procedure to determine a sub-macroblock mode decision, according to one embodiment. The operations associated with FIGS. 9 through 14 are associated with the operations of block 812 of FIG. 8.

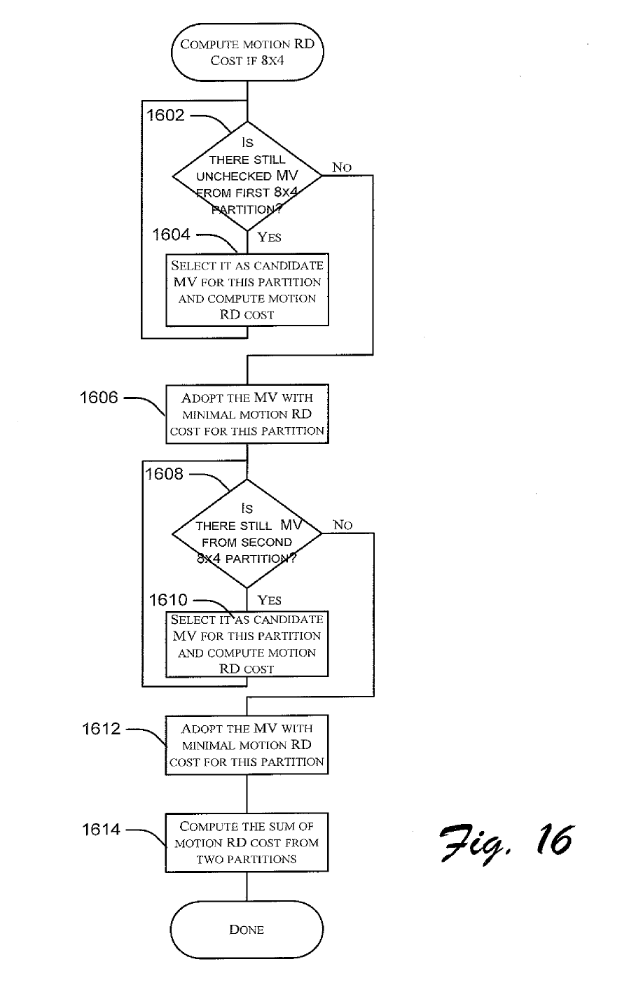

FIGS. 15-21 show exemplary respective procedures to compute motion R-D cost if the initial macroblock/submacroblock mode is based on 4×4, 8×4, 4×8, 8×8, 8×16, 16×8, or 16×16, according to respective embodiments. It can be appreciated that in a different implementation, optimized motion R-D can be based on different initial mode configurations. The operations associated with FIGS. 15 through 21 are associated with the operations of block 814 of FIG. 8.

### CONCLUSION

Although transcoding hierarchical B-frames with rate-distortion optimization in the DCT domain has been described in language specific to structural features and/or methodological operations or actions, it is understood that the implementations defined in the appended claims are not necessarily limited to the specific features or actions described. Rather, the specific features and operations discussed above with respect to FIGS. 2-8 are disclosed as exemplary forms of implementing the claimed subject matter.

1. A method at least partially implemented by a computer, the method comprising:
transcoding input media content from an original bit rate to a reduced bit rate, the input media content comprising multiple hierarchical bidirectional frames (“B-frames”), multiple intra-frames (I-frames), and multiple predictive frames (P-frames) such that for each B-frame of the multiple B-frames, the B-frame is open-loop transcoded in view of the reduced bit rate by directly optimizing texture rate-distortion (R-D) and estimating motion R-D in a DCT domain to generate a respective portion of transcoded media content; and
providing the transcoded media content comprising transcoded B-frames, I-frames, and P-frames to a user for presentation.

2. The method of claim 1, wherein the method further comprises transcoding each I-frame and each P-frame using a cascade transcoding technique to comply with a reduced bit rate and to generate a respective portion of the transcoded media content.

3. The method of claim 1, wherein the method further comprises:
transcoding, in the DCT domain, one or more pre-encoded media content streams at different bit rates with different quantizers to identify a relationship between texture distortion, texture rate, and various quantizers; and
wherein transcoding the input media content further comprises transcoding the B-frame based on the relationship.

4. The method of claim 1, wherein the method further comprises presenting the transcoded media content to the user in real-time.

5. The method of claim 1, wherein transcoding the input media content further comprises entropy decoding respective frames of the input media content to extract motion vectors and mode information from macroblocks associated with the respective frames.

6. The method of claim 1, wherein transcoding the input media content further comprises transcoding each B-frame independent of pixel domain.

7. The method of claim 1, wherein the B-frame comprises multiple macroblocks, and wherein transcoding the input media content further comprises:
transcoding the B-frame by directly and respectively estimating distortions caused by motion and mode change in view of the reduced bit rate from motion vector variation and power spectrum of prediction signals generated from the input media content; and
based on distortion estimates, refining motion and mode information for each macroblock of the B-frame to minimize motion and texture R-D rate costs.

8. The method of claim 7, wherein each macroblock is associated with one or more candidate modes, and wherein refining motion and mode information for each macroblock of the B-frame further comprises:
computing R-D cost for each candidate mode of the one or more candidate modes in view of any motion vectors of block(s) “left and/or right” and/or “top and/or bottom” of the macroblock; and
selecting a candidate mode of the one or more candidate modes with a minimum R-D cost, the candidate mode being associated with a set of motion vectors.

9. The method of claim 7, wherein the method further comprises:
calculating the power spectrum of prediction signals from a group of pictures that encapsulates the B-frame; and
wherein the power spectrum of prediction signals is used to refine the motion and the mode information for each macroblock of the B-frame and any other B-frame in the GOP.

10. The method of claim 1, wherein the B-frame comprises multiple macroblocks, and wherein transcoding the input media content further comprises:
for each macroblock of the multiple macroblocks:
optimizing texture R-D by adjusting quantization parameters in view of a targets reduced bit rate; and
optimizing motion R-D in the DCT domain by modifying motion vectors associated with the macroblock and macroblock mode in view of an initial mode associated with the macroblock and the target reduced bit rate.

11. The method of claim 10, wherein optimizing the texture R-D introduces a first type of distortion when DCT coefficients are modified, and wherein optimizing the motion R-D introduces a second type of distortion when motion information is altered independent of a full pixel-domain motion compensation loop.

12. The method of claim 10, wherein optimizing the texture R-D further comprises:
determining a value for a Lagrange multiplier based on a trained relationship between texture distortion and texture rate of multiple transcoded video content streams, each of the multiple transcoded video content streams being based on respective transcodings of multiple streams of coded media content in view of multiple different quantizers and multiple different bit rates; and
adjusting quantization parameters out of the macroblock such that texture R-D for the macroblock is minimized based on the Lagrange multiplier in view of the target reduced bit rate.

13. The method of claim 10, wherein optimizing the motion R-D in the DCT domain further comprises:
if power spectral density (PSD) of a prediction signal associated with a group of pictures (GOP) associated with the B-frame has not been determined for that GOP, calculating the PSD for the GOP;
identifying one or more candidate modes for the macroblock based on an initial mode of the macroblock;
for each candidate mode of the one or more candidate modes, estimating R-D caused by motion and mode change for the macroblocks directly from motion vector variation and the PSD; and
identifying a particular candidate mode of the one or more candidate modes associated with a particular set of motion vectors and minimal estimated R-D distortions.

14. A computer-readable medium comprising computer-program instructions executable by a processor, the computer-program instructions executed by the processor for performing operations comprising:
transcoding input media content from an original bit rate to a reduced bit rate to generate transcoded media content, the input media content comprising multiple hierarchical bidirectional frames (“B-frames”), multiple intra-frames (I-frames), and multiple predictive frames (P-frames), the B-frames being transcoded with rate-distortion modeling in a DCT domain and independent of a pixel domain; and
communicating the transcoded media content for presentation in real-time.

15. The computer-readable medium of claim 14, wherein the computer-program instructions further comprise instructions for:
transcoding, in the DCT domain, one or more pre-encoded media content streams at different bit rates with different quantizers to identify a relationship between texture distortion, texture rate, and various quantizers;
estimating a Lagrange multiplier using the relationship applied to a particular quantizer used to transcode the input media content; and
wherein transcoding the input media content further comprises transcoding B-frames in the input media content using the Lagrange multiplier.

16. The computer-readable medium of claim 14, wherein each B-frame comprises multiple macroblocks, and wherein the computer-program instructions for transcoding the input media content further comprise instructions for:
directly and respectively estimating distortions caused by motion and mode change in view of the reduced bit rate from motion vector variation and power spectrum of prediction signals generated from the input media content; and
based on distortion estimates, refining motion and mode information for each macroblock of the B-frame to minimize motion and texture R-D rate costs.

17. The computer-readable medium of claim 16, wherein each macroblock is associated with one or more candidate modes, and wherein the computer-program instructions for refining motion and mode information for each macroblock of the B-frame further comprise instructions for:
computing R-D cost for each candidate mode of the one or more candidate modes in view of any motion vectors of block(s) left and/or right of the macroblock; and
selecting a candidate mode of the one or more candidate modes with a minimum R-D cost, the candidate mode being associated with a set of motion vectors.

18. The computer-readable medium of claim 14, wherein the B-frame comprises multiple macroblocks, and wherein the computer-program instructions for transcoding the media content further comprise instructions for:
for each macroblock of the multiple macroblocks:
optimizing texture R-D by adjusting quantization parameters in view of the reduced bit rate; and
optimizing motion R-D in the DCT domain by modifying motion vectors associated with the macroblock and macroblock mode in view of an initial mode associated with the macroblock and the reduced bit rate.

19. A computing device comprising:
a processor; and
a memory coupled to the processor, memory comprising computer-program instructions executable by the processor for performing a set of operations comprising:
transcoding coded media content from one bit rate to a different bit rate to generate respective frames of transcoded media content, the coded media content comprising hierarchical bidirectional frames (B-frames);
communicating the respective frames of transcoded media content to a media content player for presentation to the user; and
wherein the transcoding is implemented by optimizing texture rate-distortion (R-D) and motion R-D in a DCT domain during B-frame transcoding operations to refine the B-frame motion vectors and integrate transcoding mode decisions in view of the different bit rate.

20. The computing device of claim 19, wherein the computer-program instructions for transcoding the coded media content further comprise instructions for:
for macroblocks associated with each B-frame, directly estimating distortions caused by motion and mode change in view of the reduced bit rate from motion vector variation and power spectrum of prediction signals generated from a group of pictures associated with the B-frame; and
based on distortion estimates, refining motion and mode information for respective ones of the macroblock to minimize motion and texture R-D rate costs.
